(19) United States
(12) Patent Application Publication
(10) Pub. No.: US 2025/0108715 A1
(43) Pub. Date: Apr. 3, 2025

(54) COOLING SYSTEM FOR CHARGING INLET ASSEMBLY FOR ELECTRIC VEHICLE

(71) Applicant: TE Connectivity Solutions GmbH, Schaffhausen (CH)

(72) Inventors: Nathan Philip Myer, Lancaster, PA (US); Kevin John Peterson, Kernersville, NC (US); Aaron James de Chazal, Rochester, MI (US); Ram Kishore Venkatesan, Winston Salem, NC (US)

(21) Appl. No.: 18/476,945

(22) Filed: Sep. 28, 2023

(51) Int. Cl. B60L 53/302; B60L 53/34

(52) U.S. Cl. CPC B60L 53/302; B60L 53/34

(57) ABSTRACT

A power connector includes a housing having terminal channels holding charging terminals for mating with a charging connector. Power conductors are terminated to cable connectors of the corresponding charging terminals. The power connector includes a cooling module thermally coupled to the charging terminals. The cooling module includes a carrier having pockets. The cooling module includes phase change elements received in the corresponding pockets and held relative to each other by the carrier. The phase change elements are thermally coupled to the corresponding cable connectors to lower operating temperatures of the charging terminals during charging.

### BACKGROUND OF THE INVENTION

The subject matter herein relates generally to charging inlet assemblies.

Electrical connectors, such as power connectors, generate heat when current flows through the terminals and cables of the power connectors. For example, a power connector of a charging inlet assembly for a battery system of an electric vehicle (EV) or hybrid electric vehicle (HEV) may generate heat through the terminals and the cables of the charging inlet assembly during a charging process. A charging connector is configured to be mated with the terminals of the charging inlet assembly to charge the battery system of the vehicle. It is desirable to increase the current transmitted through the terminals for charging the battery. However, at higher currents, the terminals and the power cables experience an increase in temperature, which may damage the components of the charging inlet assembly.

A need remains for a cooling system for cooling a power connector, such as for a charging inlet assembly.

### BRIEF DESCRIPTION OF THE INVENTION

In one embodiment, a power connector is provided and includes a housing extending between a front and a rear. The housing has terminal channels between the front and the rear. The power connector includes charging terminals coupled to the housing. Each charging terminal includes a mating pin at a front of the charging terminal and a cable connector at a rear of the charging terminal. The mating pin is positioned in the corresponding terminal channel for mating with a charging connector. The cable connector is positioned at the rear of the housing. The power connector includes power conductors terminated to the cable connectors of the corresponding charging terminals. The power connector includes a cooling module thermally coupled to the charging terminals. The cooling module includes a carrier having pockets. The cooling module includes phase change elements received in the corresponding pockets and held relative to each other by the carrier. The phase change elements are thermally coupled to the corresponding cable connectors to lower operating temperatures of the charging terminals during charging.

In another embodiment, a charging inlet assembly for an electric vehicle is provided and includes a housing extending between a front and a rear. The housing has a mounting flange configured to be mounted to the electric vehicle. The housing has a power connector with a receptacle at the front for receiving a charging connector. The power connector includes terminal channels between the front and the rear. The charging inlet assembly includes charging terminals coupled to the housing. Each charging terminal includes a mating pin at a front of the charging terminal and a cable connector at a rear of the charging terminal. The mating pin is positioned in the receptacle for mating with a charging connector. The cable connector is positioned at the rear of the housing. The charging inlet assembly includes power conductors terminated to the cable connectors of the corresponding charging terminals. The power conductors are electrically connected to a battery system of the electric vehicle. The charging inlet assembly includes a cooling module thermally coupled to the charging terminals. The cooling module includes a carrier having pockets. The cooling module includes phase change elements received in the corresponding pockets and held relative to each other by the carrier. The phase change elements are thermally coupled to the corresponding cable connectors to lower operating temperatures of the charging terminals during charging of the electric vehicle.

In a further embodiment, a cooling module for a power connector of a charging inlet assembly is provided. The cooling module includes a carrier extending between a front and a rear. The carrier has a side wall between the front and the rear. The side wall extends along a first side, a second side, a first end and a second end. The carrier has a first pocket at the first side and a second pocket at the second side. The carrier includes a separating wall between the first pocket and the second pocket. The cooling module includes a first phase change element received in the first pocket. The first phase change element is thermally coupled to a first charging terminal of the power connector. The cooling module includes a second phase change element received in the second pocket. The second phase change element is thermally coupled to a second charging terminal of the power connector. The carrier is configured to be positioned between the first and second charging terminals of the power connector such that the first side faces the first charging terminal and the second side faces the second charging terminal. The carrier holds the first and second phase change elements relative to each other to position the first and second phase change elements for thermally coupling to the first and second charging terminals.

### BRIEF DESCRIPTION OF THE DRAWINGS

FIG. 1 is a front perspective view of a power connector having a cooling module in accordance with an exemplary embodiment for cooling components of the power connector.

FIG. 2 is a rear perspective view of the power connector and the cooling module in accordance with an exemplary embodiment.

FIG. 3 is a perspective view of a portion of the power connector (with the housing removed) showing the cooling module coupled to the charging terminals 104 and the power conductors in accordance with an exemplary embodiment.

FIG. 4 is an exploded view of a portion of the power connector in accordance with an exemplary embodiment.

FIG. 5 is a perspective view of the phase change element in accordance with an exemplary embodiment.

FIG. 6 is a perspective view of the phase change element in accordance with an exemplary embodiment.

FIG. 7 is a rear perspective view of a portion of the cooling module showing the phase change elements received in the carrier in accordance with an exemplary embodiment.

FIG. 8 is a front perspective view of a portion of the cooling module showing the phase change elements received in the carrier in accordance with an exemplary embodiment.

FIG. 9 is a front perspective view of a portion of the cooling module showing the thermal interface element coupled to the carrier in accordance with an exemplary embodiment.

FIG. 10 is a perspective view of the cooling module thermally coupled to the charging terminals in accordance with an exemplary embodiment.

FIG. 11 is a graph showing charging temperature of an uncooled terminal (terminal without the cooling module) versus charging temperature of a cooled terminal (terminal having the cooling module).

### DETAILED DESCRIPTION OF THE INVENTION

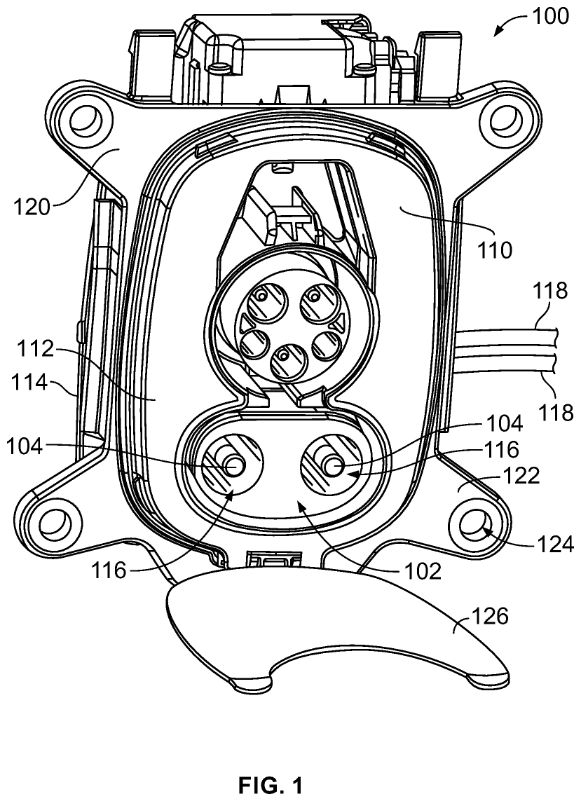

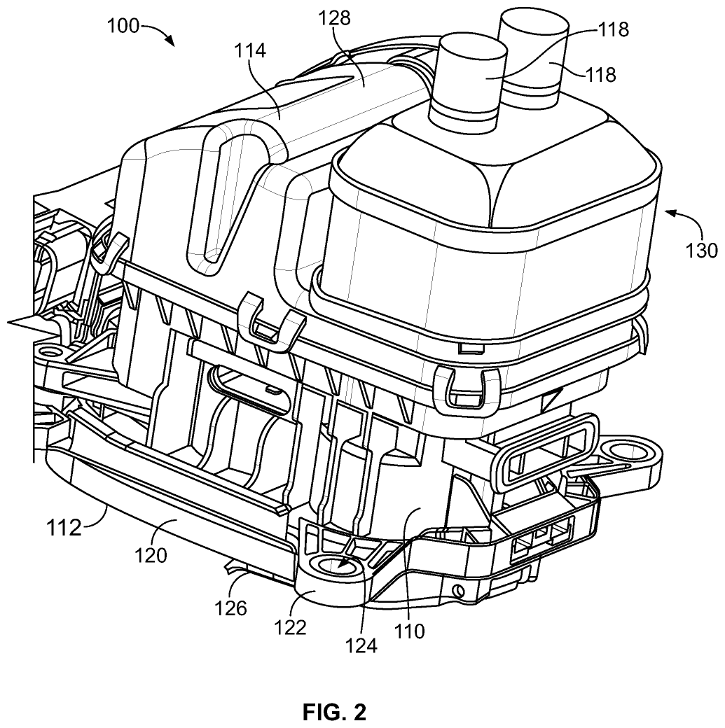

FIG. 1 is a front perspective view of a power connector 102 having a cooling module 130 in accordance with an exemplary embodiment for cooling components of the power connector 102. FIG. 2 is a rear perspective view of the power connector 102 and the cooling module 130 in accordance with an exemplary embodiment. The power connector 102 is part of a power system and includes terminals 104 configured to convey power. In various embodiments, the power connector 102 is used in a battery system. The power connector 102 may be used for charging a battery. For example, the terminals 104 may be charging terminals, such as AC charging terminals or DC charging terminals. In other embodiments, the power connector 102 may be used for powering a component, such as a motor or other electrical component. In the illustrated embodiment, the power connector 102 and the cooling module 130 are part of a charging inlet assembly 100 for an electric vehicle. However, it is realized that the power connector 102 and the cooling module 130 may be another type of electrical connector and/or may be used in another type of system or application.

The charging inlet assembly 100 is used as a charging inlet for a vehicle, such as an electric vehicle (EV) or hybrid electric vehicle (HEV). The charging inlet assembly 100 includes the power connector 102 configured for mating reception with a charging connector (not shown). The charging terminals 104 are configured to be mated with the charging connector. In the illustrated embodiment, the charging terminals 104 include AC charging terminals and DC charging terminals. In an exemplary embodiment, the power connector 102 is configured for mating with a DC fast charging connector, such as the SAE combo CCS charging connector, or other types of connectors, such as the SAE J1772 charging connector.

The charging inlet assembly 100 includes a housing 110 holding charging terminals 104. The housing 110 and the charging terminals 104 form parts of the power connector 102. The housing 110 extends between a front 112 and a rear 114. The front 112 defines a mating end of the power connector 102. The charging terminals 104 are provided at the front 112 to interface with the charging connector. The charging terminals 104 are received in terminal channels 116 and coupled to the housing 110 in the terminal channels 116. The terminal channels 116 extend between the front 112 and the rear 114. The charging terminals 104 are electrically connected to corresponding power conductors 118. The power conductors 118 may be power cables, busbars, or other types of conductors. The power conductors 118 extend from the rear 114.

In an exemplary embodiment, the power connector 102 and the charging inlet assembly 100 include the cooling module 130 for reducing the charging temperature of the charging terminals 104 and the power conductors 118 during charging. For example, the cooling module 130 includes phase-change material (PCM), which absorbs energy/heat at phase transition to provide relative or comparable cooling (for example, operating at reduced temperature compared to use without the PCM). The PCM absorbs energy during the phase transition (for example, from solid to liquid) at a phase change temperature (PCT). For example, the PCM absorb large amounts of heat at an almost constant temperature until all the material is melted at the PCT to absorb heat during the charging process. By melting (for example, changing from a solid to a liquid) at the phase-change temperature (PCT), the PCM is capable of storing large amounts of energy compared to sensible heat storage. The PCM may be a latent heat storage (LHS) material. In various embodiments, the PCM may be an organic PCM, including hydrocarbons such as paraffins, lipids, sugar alcohols, and the like. In other various embodiments, the PCM may be an inorganic PCM, including salt hydrates. In other embodiments, the PCM may be a solid-solid PCM that undergoes a solid/solid phase transition, whereby the material changes crystalline structure from one lattice configuration to another at a fixed and well-defined temperature.

The charging inlet assembly 100 includes a mounting flange 120 coupled to the housing 110. The mounting flange 120 is used to couple the charging inlet assembly 100 to the vehicle. The mounting flange 120 includes mounting tabs 122 having openings 124 that receive fasteners (not shown) used to secure the charging inlet assembly 100 to the vehicle. Other types of mounting features may be used to secure the charging inlet assembly 100 to the vehicle. The mounting flange 120 may include a seal to seal the charging inlet assembly 100 to the vehicle.

The charging inlet assembly 100 includes a terminal cover 126 (FIG. 1) hingedly coupled to the mounting flange 120 and/or the housing 110. The terminal cover 126 is used to cover the corresponding charging terminals 104. The housing 110 may include a rear cover 128 (FIG. 2) at a rear of the housing 110 that closes access to the rear of the housing 110. The rear cover 128 may be clipped onto the main part of the housing 110, such as using clips or latches. Other types of securing features, such as fasteners may be used in alternative embodiments.

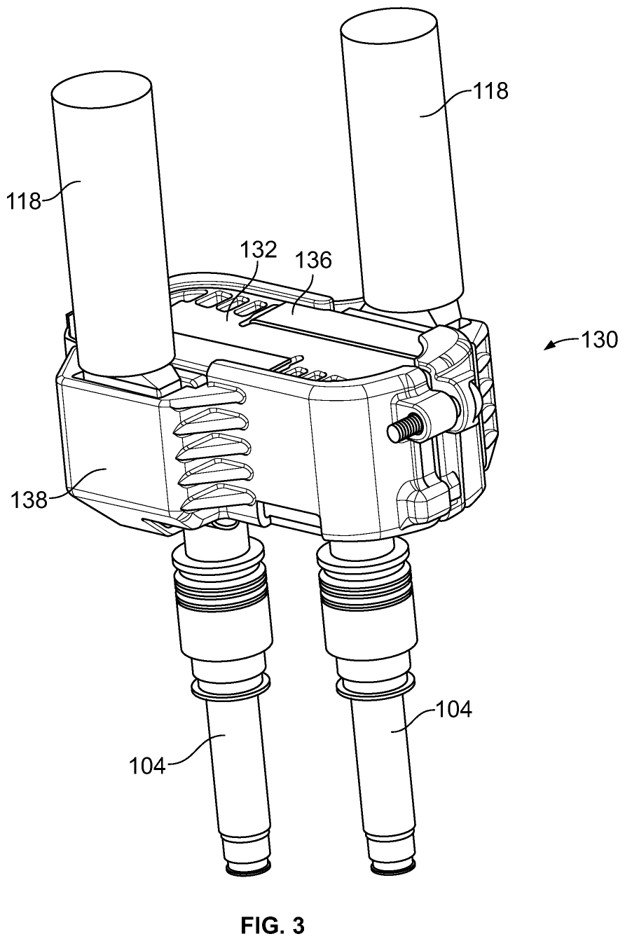

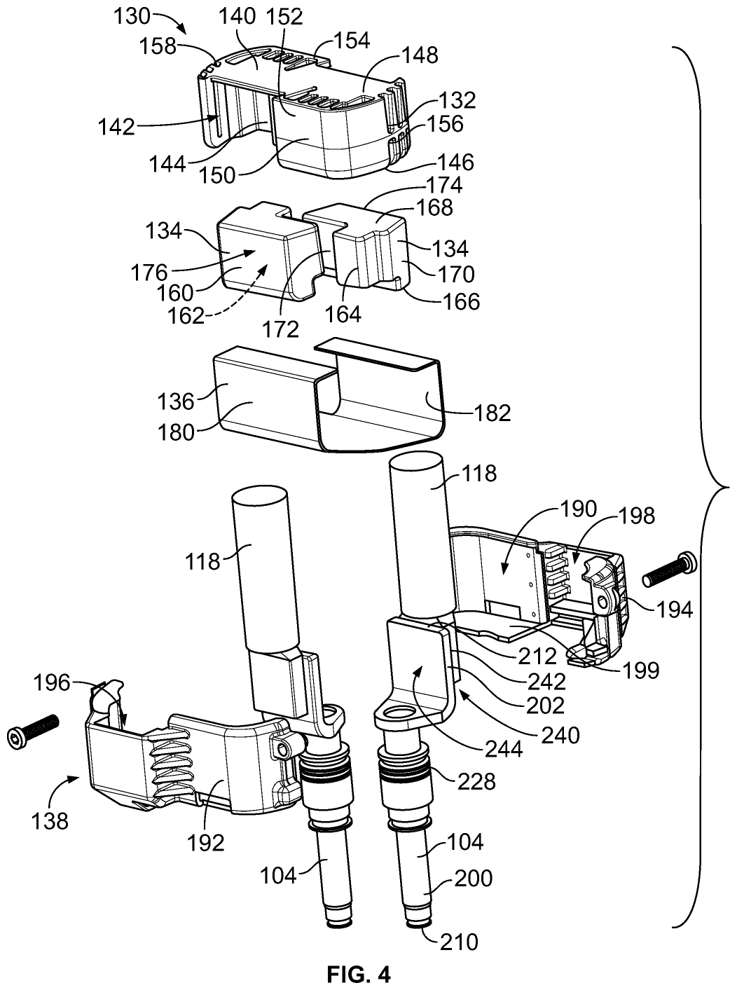

FIG. 3 is a perspective view of a portion of the power connector 102 (with the housing removed) showing the cooling module 130 coupled to the charging terminals 104 and the power conductors 118. FIG. 4 is an exploded view of a portion of the power connector 102. The cooling module 130 is used for lower operating temperatures of the charging terminals 104. In the illustrated embodiment, the power connector 102 includes a pair of the charging terminals 104 and corresponding power conductors 118. However, the power connector 102 may include greater or fewer charging terminals 104 and power conductors 118. In the illustrated embodiment, the cooling module 130 operates on multiple charging terminals 104. However, in alternative embodiments, multiple cooling modules 130 (for example, separate and discrete cooling modules) may be provided, such as individual cooling modules 130 for the individual charging terminals 104. The separate cooling modules 130 may be coupled together to form a unified or united structure.

Each charging terminal 104 includes a mating pin 200 at a front 210 of the charging terminal 104 and a cable connector 202 at a rear 212 of the charging terminal 104. The mating pin 200 is configured to be mated to the charging connector. The cable connector 202 is configured to be electrically connected to the power conductor 118. During charging, the temperature of the mating pin 200 and the cable connector 202 increases. In an exemplary embodiment, the rate of temperature increase mitigated or slowed by the cooling module 130.

In various embodiments, the cable connector 202 is separate and discrete from the mating pin 200 and configured to be mechanically and electrically coupled to the mating pin 200. For example, the cable connector 202 may be press fit onto the mating pin 200. However, the cable connector 202 may be secured to the mating pin 200 by other processes in alternative embodiments, such as welding, riveting, a bolted joint, and the like. In other various embodiments, the cable connector 202 is integral with the mating pin 200, such as formed with the mating pin 200. In various embodiments, the cable connector 202 is configured to be terminated to the power conductor 118 by welding the power conductor 118 to the cable connector 202. For example, the cable connector 202 may include a weld tab. In other various embodiments, the cable connector 202 is terminated to the power conductor 118 by other processes, such as being crimped, soldered, and the like. For example, the cable connector 202 may include a crimp barrel configured to be terminated to the power conductor 118.

The mating pin 200 is electrically conductive. For example, the mating pin 200 may be manufactured from a metal material, such as a copper material. In an exemplary embodiment, the mating pin 200 is screw machined. The mating pin 200 may be manufactured from a metal alloy (for example, copper alloy) having additives to increase machinability. In an exemplary embodiment, the mating pin 200 is cylindrical. In an exemplary embodiment, a seal 228 is coupled to the mating pin 200 near a rear end of the mating pin 200 for interface sealing against an interior surface of the terminal channel 116 (shown in FIG. 1).

The cable connector 202 extends from and/or is coupled to the rear end of the mating pin 200. The cable connector 202 may be press-fit on the mating pin 200. The cable connector 202 includes a cable terminating end 240 at the rear 212 of the charging terminal 104. The power conductor 118 is configured to be terminated to the cable terminating end 240. In the illustrated embodiment, the cable connector 202 includes a weld pad 242 at the rear 212 defining the cable terminating end 240. The weld pad 242 may be rectangular or have other shapes in alternative embodiments. The weld pad 242 may include planar, parallel surfaces for welding the power conductor 118 to the weld pad 242. The cable terminating end 240 may include a crimp barrel (not shown) rather than the weld pad 242 in alternative embodiments. In an exemplary embodiment, the cable connector 202 includes a thermal interface 244. The cooling module 130 is configured to thermally connect to the thermal interface 244. The thermal interface 244 may be provided along the weld pad 242, such as along the planar surface of the weld pad 242 opposite the power conductor 118.

The cooling module 130 includes a carrier 132 and one or more phase change elements 134. The phase change elements 134 are configured to be thermally coupled to the charging terminals 104. The phase change elements 134 dissipate heat from the charging terminals 104, such as to slow the temperature rise in the charging terminals during the charging process. In various embodiments, the cooling module 130 includes a thermal interface element 136 providing an interface between the phase change elements 134 and the charging terminals 104. However, in alternative embodiments, the phase change elements 134 may be directly thermally coupled to the charging terminals 104 without the use of the thermal interface element 136. In various embodiments, the cooling module 130 includes a shell 138 holding the carrier 132, the phase change elements 134 and the thermal interface element 136. However, the components of the cooling module 130 may be coupled to the charging terminals 104 by other means or securing elements in alternative embodiments.

The carrier 132 holds the phase change elements 134. In various embodiments, the carrier 132 holds all of the phase change elements 134 (for example, a pair of the phase change elements 134. However, in alternative embodiments, multiple carriers 132 may be provided, each holding a corresponding phase change element 134. In an exemplary embodiment, the carrier 132 includes a body 140 manufactured from an electrically insulating material. For example, the body 140 of the carrier 132 may be manufactured from a plastic material. In various embodiments, the body 140 of the carrier 132 is manufactured from a thermally conductive material, such as to dissipate heat from the phase change elements 134 and/or the charging terminals 104.

The carrier 132 includes one or more pockets 142 that receive the phase change elements 134. In the illustrated embodiment, the carrier 132 includes a pair of the pockets 142. The carrier 132 may include greater or fewer pockets 142 in alternative embodiments. The carrier 132 includes a separating wall 144 between the pockets 142. The separating wall 144 isolates the pockets 142, and thus the phase change elements 134 from each other.

The carrier 132 extends between a front 146 and a rear 148. The carrier 132 includes a side wall 150 extending between the front 146 and the rear 148. The side wall 150 surrounds a perimeter of the carrier 132. The pockets 142 may be open along the side wall 150 to allow the phase change elements 134 to interface with the corresponding charging terminals 104. In an exemplary embodiment, the pockets 142 are open at the front 146 to receive the phase change elements 134. For example, the phase change elements 134 may be front loaded into the pockets 142. Optionally, the pockets 142 may be closed at the rear 148. However, in alternative embodiments, the pockets 142 may be open at the rear 148, such as to receive the phase change elements 134 or allow a heatsink or other heat dissipating element to interface with the phase change elements 134. In an exemplary embodiment, the carrier 132 includes a first side 152 and a second side 154. The carrier 132 includes a first end 156 and a second end 158. The side wall 150 extends along the first and second sides 152, 154 and the first and second ends 156, 158. In the illustrated embodiment, the first and second sides 152, 154 are generally planar. For example, the first and second sides 152, 154 may be oriented parallel to each other. However, the first and second sides 152, 154 may be curved in alternative embodiments. In an exemplary embodiment, the first and second ends 156, 158 are curved between the first and second sides 152, 154. However, in alternative embodiments, the first and second ends 156, 158 may include flat portions that are parallel to each other. The carrier 132 may have other shapes in alternative embodiments.

In an exemplary embodiment, the carrier 132 has a volume defined by the side wall 150 between the front 146 and the rear 148. In an exemplary embodiment, the pockets 142 occupy a majority of the volume of the carrier 132 such that the phase change elements 134 may occupy a large portion of the volume, such as greater than 50% of the volume. In various embodiments, the phase change elements 134 may occupy greater than 75% of the volume. In some embodiments, the phase change elements 134 may occupy greater than 90% of the volume. In an exemplary embodiment, the carrier 132 includes features to position and or retain the phase change elements 134 in the pockets 142. For example, the carrier 132 may include crush ribs and/or positioning ribs and/or tabs, bottoms or other protrusions extending into the pockets 142 to interface with the phase change elements 134. In other various embodiments, the carrier 132 may include wells, slots, grooves, or other features extending into the body 140 of the carrier 132 to receive them position the phase change elements 134 in the pocket 142. Other types of securing features may be used to secure the phase change elements 134 in the pocket 142, such as latches, clips, fasteners, adhesive, covers, and the like.

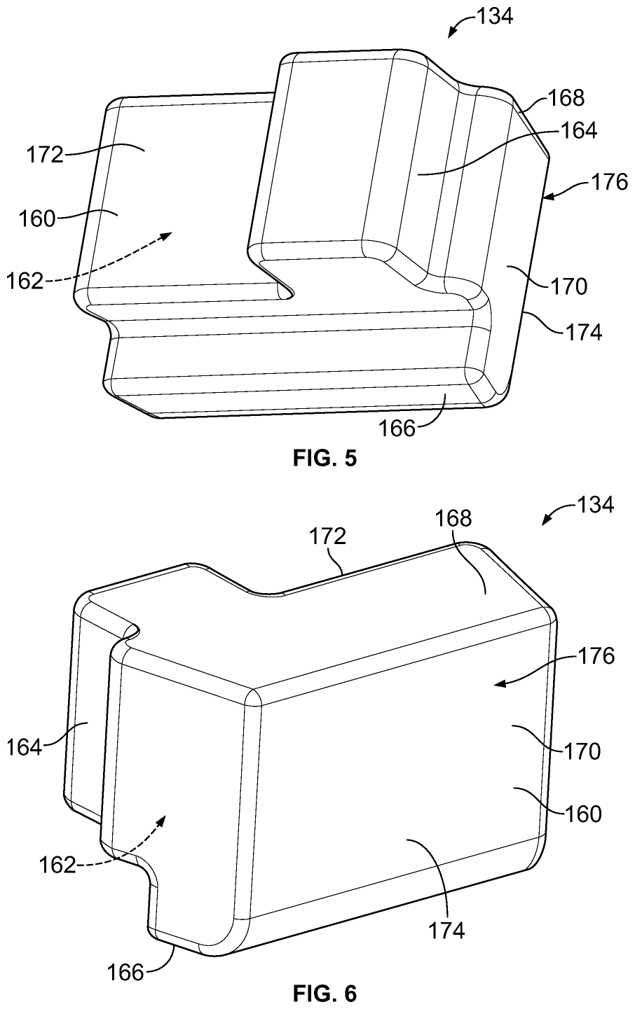

With additional reference to FIGS. 5 and 6, which are perspective views of the phase change element 134 in accordance with an exemplary embodiment, each phase change element 134 includes an enclosure 160 surrounding phase change material (PCM) 162. The enclosure 160 may be a film, a sheet, a molded body, or another type of enclosure that surrounds and contains the phase change material 162. The enclosure 160 is sized and shaped to fit in the pocket 142. For example, the phase change element 134 may have a shape that is complementary to the shape of the pocket 142. The enclosure 160 may include locating features 164 for positioning the phase change element 134 in the pocket 142.

The phase change element 134 extends between a front 166 and a rear 168. The phase change element 134 includes a side wall 170 between the front 166 and the rear 168. The phase change element 134 includes an inner portion 172 and an outer portion 174. The outer portion 174 forms a thermal interface 176 configured to face the charging terminal 104. In an exemplary embodiment, the thermal interface 176 is planar. The thermal interface 176 is a large surface area configured to face the charging terminal 104 for efficient thermal transfer between the charging terminal 104 and the phase change element 134.

The PCM 162 is a material configured to absorb large amounts of heat at an almost constant temperature until the material changes phases/states. For example, the PCM 162 is manufactured from a material that undergoes solid/liquid phase transition at a phase change temperature. In an exemplary embodiment, the PCM 162 includes hydrocarbons such as paraffins, lipids, sugar alcohols, and the like. In other various embodiments, the PCM 162 includes salt hydrates. In other embodiments, the PCM 162 includes a material that undergoes a solid/solid phase transition, whereby the material changes crystalline structure from one lattice configuration to another at a fixed and well-defined temperature. The phase change element 134 allows lower operating temperature for the charging terminal 104 by absorbing heat from the charging terminal 104 during the charging process, effectively prolonging the charging time and/or lowering the charging temperature of the charging terminal 104 during the charging cycle (for example, compared to use without the PCM). The PCM 162 absorbs energy during the phase transition (for example, from solid to liquid) at the phase change temperature (PCT). For example, the phase change element 134 absorb large amounts of heat at an almost constant temperature until all the PCM 162 is melted at the phase change temperature to absorb heat during the charging process. By melting (for example, changing from a solid to a liquid) at the phase-change temperature (PCT), the PCM 162 is capable of storing large amounts of energy compared to sensible heat storage. The PCM 162 may be a latent heat storage (LHS) material.

With reference back to FIGS. 3 and 4, the thermal interface element 136 may be provided between the phase change elements 134 and the charging terminals 104 to enhance thermal coupling between the phase change elements 134 and the charging terminals 104. In an exemplary embodiment, the thermal interface element 136 is a thermal interface sheet, such as a film or tape. For example, the thermal interface sheet may be a metal sheet having high thermal conductivity and lower thermal interface resistance. The thermal interface element 136 may be a thermally conductive pad in alternative embodiments. In other various embodiments, the thermal interface element 136 may be a thermal paste or thermal adhesive that is used between the phase change elements 134 and the charging terminals 104.

In an exemplary embodiment, the thermal interface element 136 is flexible to conform between the surfaces of the phase change elements 134 and the charging terminals 104. The thermal interface element 136 includes an inner interface 180 configured to face and interface with the corresponding phase change element 134 and an outer interface 182 configured to face and interface with the corresponding charging terminal 104. The interfaces 180, 182 may be generally planar. However, the interfaces 180, 182 may be nonplanar in other embodiments to conform with and engage the phase change elements 134 and the charging terminals 104.

In the illustrated embodiment, a single thermal interface element 136 is provided that is used to cover both of the phase change element 134. However, in alternative embodiments, multiple thermal interface elements 136 may be provided, such as one at each of the phase change element 134. In an exemplary embodiment, the thermal interface element 136 wraps around portions of the carrier 132 to cover the phase change elements 134. For example, the thermal interface element 136 may wrap around portions of the side wall 150. The thermal interface element 136 may wrap from the front 146 and/or the rear 148. In an exemplary embodiment, the thermal interface element 136 may be adhered or otherwise secured to portions of the carrier 132, such as the rear 148 and/or the front 146 and/or the side wall 150. In various embodiments, the thermal interface element 136 may cover the pockets 142 to retain the phase change elements 134 in the pockets 142. In an exemplary embodiment, the thermal interface element 136 is manufactured from a thermally conductive, and electrically insulating material to avoid creating an electrical pathway between the charging terminals 104. For example, the thermal interface element 136 may be a fiberglass reinforced silicone having sheets of fiberglass coated with thermally conductive silicone rubber or may be a polyimide film coated with a ceramic filled, high-temperature silicone rubber.

The shell 138 is used as a housing to hold the components of the cooling module 130 together. The shell 138 may be used to support the charging terminals 104. The shell 138 includes a chamber 190. The carrier 132, the phase change elements 134, the thermal interface element 136 and the charging terminals 104 are received in the chamber 190. In an exemplary embodiment, the phase change elements 134 and the thermal interface element 136 are thermally coupled to the charging terminals 104 in the chamber 190. The shell 138 may be used to position the charging terminals 104 relative to each other, such as at fixed positions or spacing relative to each other, such as for loading into the charging inlet housing.

In an exemplary embodiment, the shell 138 is a multipiece structure. For example, the shell 138 includes a first shell member 192 and a second shell member 194. The first and second shall members 192, 194 are coupled together, such as using fasteners. The chamber 190 is defined between the first and second shall members 192, 194. Optionally, the first and second shall members 192, 194 may be similar to each other, such as being mirrored halves.

In an exemplary embodiment, the first shell member 192 includes a first terminal pocket 196 and the second shell member 194 includes a second terminal pocket 198. The terminal pockets 196, 198 receive the corresponding charging terminals 104. The terminal pockets 196, 198 may include locating features for locating or positioning the charging terminals 104 relative to the shell 138. The shell 138 may be open at the front to allow the pins 200 of the charging terminals 104 to extend forward of the shell 138. The shell 138 may be open at the rear to allow the power conductors 118 to extend rearward from the shell 138. The shell 138 may include cable exits at other locations other than the rear in alternative embodiments, such as at the sides to allow 90° exit of the power conductors 118 from the shell 138.

In an exemplary embodiment, the shell 138 includes front walls 199 at the front that are used to support the carrier 132 and/or the phase change elements 134. For example, the front walls 199 may be used to retain the phase change elements 134 in the pockets 142 of the carrier 132. The shell 138 may have other sizes or shapes in alternative embodiments. When assembled, the carrier 132 and the phase change elements 134 are received in the chamber 190 of the shell 138. In an exemplary embodiment, the first and second shall members 192, 194 receive the charging terminals 104 on opposite sides of the chamber 190 with the carrier 132 and the phase change elements 134 located between the charging terminals 104. As the first and second shell members 192, 194 are coupled together, the shell members 192, 194 press the charging terminals 104 into thermal contact with the phase change elements 134 and/or the thermal interface element 136. For example, as the fasteners are tightened, the charging terminals 104 are pressed inward into physical contact with the phase change elements 134 and/or the thermal interface element 136. The direct physical contact allows for efficient thermal transfer between the charging terminals 104 and the phase change elements 134 and/or the thermal interface element 136. Heat generated in the charging terminals 104 is absorbed by the phase change elements 134 through the thermal interface element 136 reducing the temperature or slowing the temperature rise in the charging terminals 104 during the charging process.

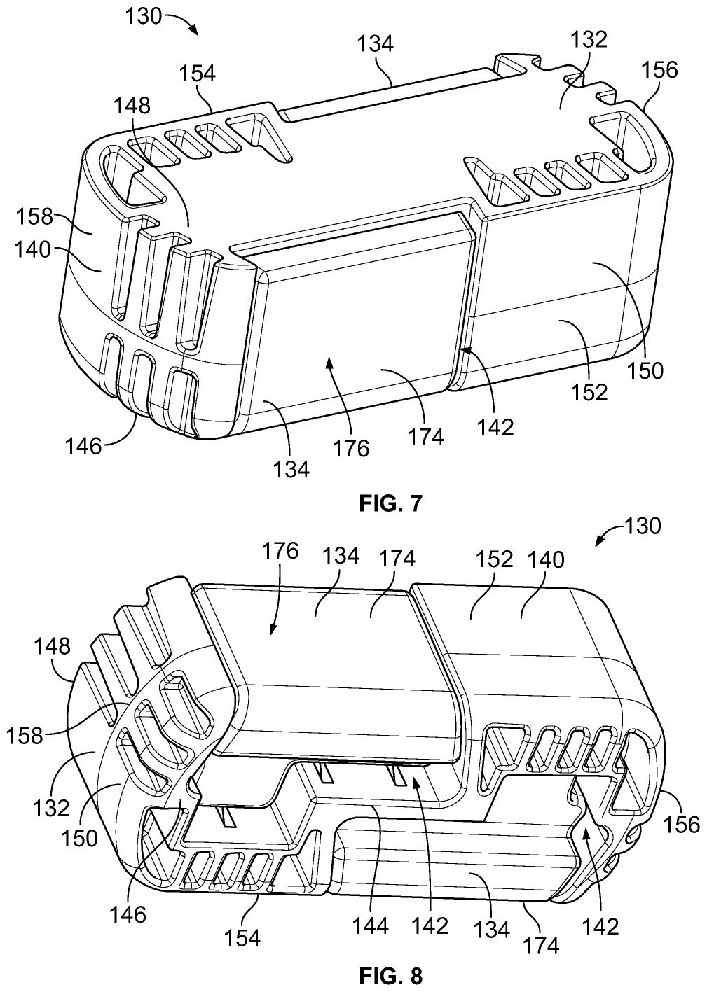

FIG. 7 is a rear perspective view of a portion of the cooling module 130 showing the phase change elements 134 received in the carrier 132 in accordance with an exemplary embodiment. FIG. 8 is a front perspective view of a portion of the cooling module 130 showing the phase change elements 134 received in the carrier 132 in accordance with an exemplary embodiment.

During assembly, the phase change elements 134 are received in the pockets 142 of the carrier 132, such as through the front 146. The phase change elements 134 may bottom out against rear walls at the rear 148 of the carrier 132. The separating wall 144 is located between the pockets 142. The separating wall 144 separates the phase change elements 134 from each other. The body 140 of the carrier 132 may have air pockets to enhance cooling of the carrier 132 and thus reduce the overall temperature of the cooling module 130. Optionally, the carrier 132 may include interference ribs in the pockets 142 that holds the phase change elements 134 in the pockets 142 by an interference fit. Other types of locating and/or securing features may be provided in alternative embodiments. The carrier 132 may be shaped to retain the phase change elements 134 in the pockets 142. For example, the side wall 150 at the pockets 142 may have a dovetail shape to prevent the phase change elements 134 from being extracted through the side wall 150. In an exemplary embodiment, the outer portions 174 of the phase change elements 134 include the thermal interfaces 176. The thermal interfaces 176 may be generally coplanar with the sides 152, 154 of the carrier 132. However, in alternative embodiments, the thermal interfaces 176 may protrude from the carrier 132 to interface with the charging terminals 104.

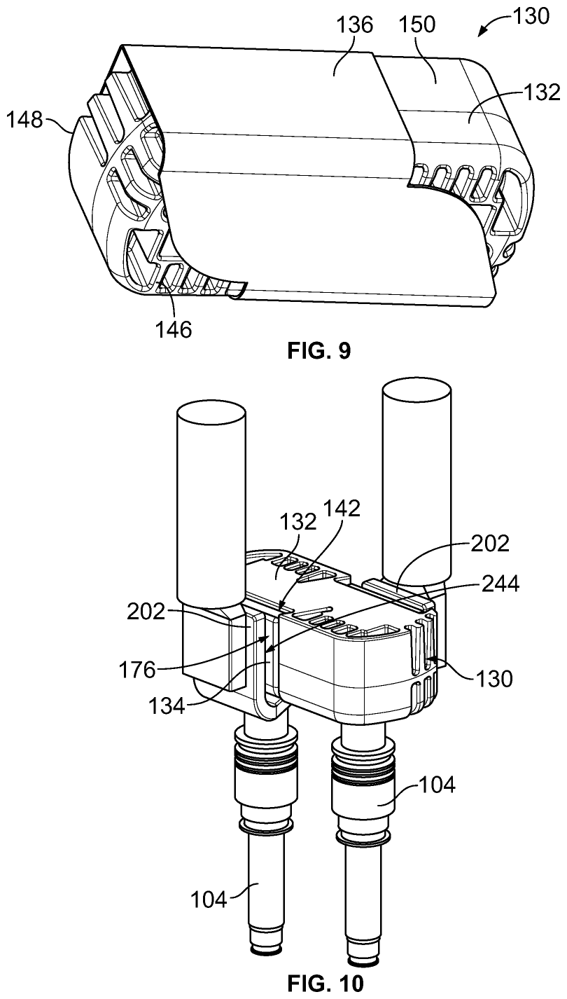

FIG. 9 is a front perspective view of a portion of the cooling module 130 showing the thermal interface element 136 coupled to the carrier 132 in accordance with an exemplary embodiment. In an exemplary embodiment, the thermal interface element 136 wraps around a portion of the carrier 132. For example, portions of the thermal interface element 136 may be secured to the rear 148 of the carrier 132 and wrap around the side wall 150 and the front 146. The thermal interface element 136 may be adhered to the rear 148 and/or the side wall 150 and/or the front 146. The thermal interface element 136 covers the pockets 142 and the phase change elements 134 located in the pockets 142. The thermal interface element 136 is configured to interface with the charging terminals 104 to transfer heat between the charging terminals 104 and the phase change elements 134.

FIG. 10 is a perspective view of the cooling module 130 thermally coupled to the charging terminals 104 in accordance with an exemplary embodiment. In the illustrated embodiment, the cooling module 130 is provided without the thermal interface element 136 (FIG. 9) and without the shell 138 (FIG. 3). The phase change elements 134 are located in the pockets 142 of the carrier 132. The phase change elements 134 directly interface with the charging terminals 104. For example, the thermal interfaces 176 of the phase change elements 134 directly interface with the thermal interface 244 of the cable connectors 202 of the charging terminals 104.

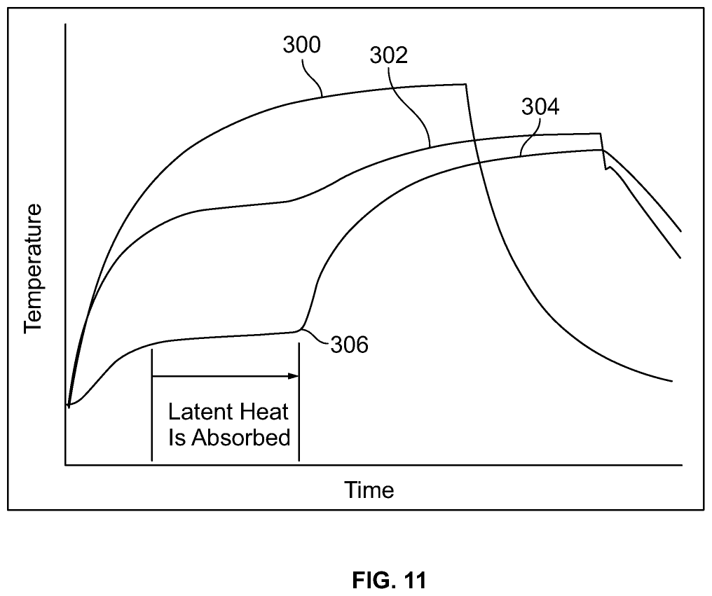

FIG. 11 is a graph showing charging temperature 300 of an uncooled terminal (terminal without the cooling module 130) versus charging temperature 302 of a cooled terminal (terminal having the cooling module 130). The charging temperature 302 of the cooled terminal is lower than the charging temperature 300 of the uncooled terminal. The cooling module lowers the operating temperature of the terminal by absorbing heat from the terminal. The graph shows the operating temperature 304 of the cooling module (for example, the operating temperature of the phase change material) of the phase change element. The phase change element absorbs latent heat, at a generally constant temperature, until the phase change temperature 306 is reached. The cooled terminal is able to undergo charging for a longer charging cycle at a lower temperature than the uncooled terminal.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A power connector comprising:
a housing extending between a front and a rear, the housing having a terminal channels between the front and the rear;
charging terminals coupled to the housing, each charging terminal including a mating pin at a front of the charging terminal and a cable connector at a rear of the charging terminal, the mating pin positioned in the corresponding terminal channel for mating with a charging connector, the cable connector positioned at the rear of the housing;
power conductors terminated to the cable connectors of the corresponding charging terminals; and
a cooling module thermally coupled to the charging terminals, the cooling module including a carrier having pockets, the cooling module including phase change elements received in the corresponding pockets and held relative to each other by the carrier, the phase change elements being thermally coupled to the corresponding cable connectors to lower operating temperatures of the charging terminals during charging.

2. The power connector of claim 1, wherein the carrier includes a separating wall between the pockets to isolate the phase change elements from each other.

3. The power connector of claim 1, wherein the pockets are open at sides of the carrier to allow the phase change elements to interface with the charging terminals.

4. The power connector of claim 1, wherein the carrier has a volume, the phase change elements occupying at least 50% of the volume.

5. The power connector of claim 1, wherein the phase change elements are configured to directly engage the charging terminals.

6. The power connector of claim 1, wherein the cooling module further comprises at least one thermal interface element between the phase change elements and the charging terminals.

7. The power connector of claim 6, wherein the at least one thermal interface element is secured to the carrier to cover the corresponding pockets.

8. The power connector of claim 1, wherein each phase change element includes a cover enclosing phase change material, the cover having a shape complementary to a shape of the pocket.

9. The power connector of claim 1, wherein the cooling module further comprises a shell having a chamber, the carrier being received in the chamber, the shell configured to be coupled to the charging terminals to secure the cooling module to the charging terminals.

10. The power connector of claim 9, wherein the cable connectors of the charging terminals are received in the chamber.

11. The power connector of claim 9, wherein the shell, the carrier, the phase change elements, and the charging terminals are configured to be loaded into the housing and removed from the housing as a unit.

12. The power connector of claim 9, wherein the shell includes a first shell member and a second shell member, the first and second shell members and coupled together to compress the thermal interfaces between the phase change elements and the charging terminals.

13. The power connector of claim 1, wherein the carrier extends between a front and a rear, the carrier having a side wall between the front and the rear, the side wall extending along a first side, a second side, a first end and a second end, the pockets including a first pocket at the first side and a second pocket at the second side, the carrier including a separating wall between the first pocket and the second pocket.

14. A charging inlet assembly for an electric vehicle comprising:
a housing extending between a front and a rear, the housing having a mounting flange configured to be mounted to the electric vehicle, the housing having a power connector with a receptacle at the front for receiving a charging connector, the power connector including terminal channels between the front and the rear;
charging terminals coupled to the housing, each charging terminal including a mating pin at a front of the charging terminal and a cable connector at a rear of the charging terminal, the mating pin positioned in the receptacle for mating with a charging connector, the cable connector positioned at the rear of the housing;
power conductors terminated to the cable connectors of the corresponding charging terminals, the power conductors being electrically connected to a battery system of the electric vehicle; and
a cooling module thermally coupled to the charging terminals, the cooling module including a carrier having pockets, the cooling module including phase change elements received in the corresponding pockets and held relative to each other by the carrier, the phase change elements being thermally coupled to the corresponding cable connectors to lower operating temperatures of the charging terminals during charging of the electric vehicle.

15. The charging inlet assembly of claim 14, wherein the carrier includes a separating wall between the pockets to isolate the phase change elements from each other.

16. The charging inlet assembly of claim 14, wherein the cooling module further comprises a shell having a chamber, the cable connectors of the charging terminals being received in the chamber, the carrier being received in the chamber to interface with the phase change elements with the charging terminals, the shell configured to be coupled to the charging terminals to secure the cooling module to the charging terminals.

17. A cooling module for a power connector of a charging inlet assembly, the cooling module comprising:
a carrier extending between a front and a rear, the carrier having a side wall between the front and the rear, the side wall extending along a first side, a second side, a first end and a second end, the carrier having a first pocket at the first side and a second pocket at the second side, the carrier including a separating wall between the first pocket and the second pocket;
a first phase change element received in the first pocket, the first phase change element being thermally coupled to a first charging terminal of the power connector; and
a second phase change element received in the second pocket, the second phase change element being thermally coupled to a second charging terminal of the power connector;
wherein the carrier is configured to be positioned between the first and second charging terminals of the power connector such that the first side faces the first charging terminal and the second side faces the second charging terminal, the carrier holding the first and second phase change elements relative to each other to position the first and second phase change elements for thermally coupling to the first and second charging terminals.

18. The cooling system of claim 17, wherein the first pocket is open at the first side of the carrier and the second pocket is open at the second side of the carrier to allow the first and second phase change elements to interface with the first and second charging terminals.

19. The cooling system of claim 17, wherein the cooling module further comprises at least one thermal interface element covering the first and second phase change elements, the at least one thermal interface element defining thermal interfaces between the first and second phase change elements and the charging terminals.

20. The cooling system of claim 17, further comprising a shell having a chamber, the carrier being received in the chamber, the shell configured to be coupled to the first and second charging terminals to secure the carrier to the charging terminals.
